(19) United States
(12) Patent Application Publication
(10) Pub. No.: US 2012/0196254 A1
(43) Pub. Date: Aug. 2, 2012

(54) METHODS AND SYSTEMS FOR CONCURRENT TEACHING OF ASSEMBLY PROCESSES AT DISPARATE LOCATIONS

(76) Inventors: Bobby Joe Marsh, Lake Stevens, WA (US); Peter E. Covell, Seattle, WA (US); Michael M. Vander Wel, Lynnwood, WA (US)

(21) Appl. No.: 13/015,185

(22) Filed: Jan. 27, 2011

(51) Int. Cl. G09B 5/00; G09B 19/00

(52) U.S. Cl. 434/219; 434/308

(57) ABSTRACT

A method for teaching an aircraft assembly method to students at locations separate from the location of an instructor is described. The method includes providing, from the instructor location, a first video feed based on a line of sight of the instructor and a second video feed being a field view of the assembly area. The video feeds are received at the disparate locations for display within a line of sight of the students such that the students may view the instructor performing the assembly method concurrent with the students performing the assembly method. Like video feeds are provided from the student locations such that the instructor may view at least one of the students performing the assembly method concurrent with the instructor performing the assembly method.

### BACKGROUND

The field of the disclosure relates generally to training, and specifically, to methods and systems for concurrent teaching of assembly processes at disparate locations.

In one example, certain aircraft models are assembled at a number of different locations. Generally, fabrication processes are developed at one location, and those processes are then implemented at the other assembly locations. However, due to the level of detail that is prevalent in the aircraft fabrication industry, implementation of processes developed at a “master” location, are not always easily implemented at the other fabrication locations.

In a specific example, one group of final assembly and delivery (FAD) tool engineers, that have developed a FAD process for fabrication and/or installation of a specific aircraft or aircraft component at a first location, generally must travel to the other fabrication locations to teach their FAD process. This travel is required because aircraft fabrication processes include many nuances, learned by the FAD process developers over time. Such fabrication locations may be dispersed internationally. Traveling to such places is expensive and inefficient.

The travel incurred by these FAD process teachers further results in many lost production hours as such persons are performing “out of position work”. Simply, they are not performing their fabrication work at the so called master location when they are at the other fabrication locations teaching their counterparts the FAD processes. However, such inefficiencies can be overcome to a certain extent by eliminating the large amount of out of position work that is currently performed by the FAD process teachers.

### BRIEF DESCRIPTION

In one aspect, a method for teaching an aircraft assembly method to students at locations separate from the location of an instructor is provided. The method includes providing, from the instructor location, a first video feed and a second video feed, the first video feed based on a line of sight of the instructor, the second video feed being a field view of the assembly area, receiving the first video feed and the second video feed at the disparate locations for display of at least one of the first video feed and the second video feed within a line of sight of the students such that the students may view the instructor performing the assembly method concurrent with the students performing the assembly method, providing, from the student locations, third video feeds based on a line of sight of the individual students and fourth video feeds being a field view of the assembly areas associated with the individual students, and receiving the third video feeds and the fourth video feeds at the instructor location for display of at least one of the third video feeds and the fourth video feeds within a line of sight of the instructor such that the instructor may view at least one of the students performing the assembly method concurrent with the instructor performing the assembly method.

In another aspect, a real-time training system is provided that includes a user mountable camera and monitor at a first location, a user mountable monitor at the first location, a field view camera at the first location, a user mountable camera and monitor at each of a plurality of second locations, a user mountable monitor at each of the second locations, a field view camera at each of the second locations, and a switching mechanism operable such that users at the second locations are provided video feeds onto the user mountable monitors at the second locations from at least one of the user mountable camera and the field view camera at the first location and the user at the first location is provided video feeds onto the user mountable monitors at the first location from at least one of the user mountable camera and the field view camera at the second location.

In still another embodiment, a parallel assembly method is provided that includes providing a bi-directional audio communications path between a first person at a first location and a second person at a second location, transmitting, from the first assembly location, at least one video feed of the first person performing an assembly task at the first location, receiving, at the second location, the at least one video feed for display on a screen within a monocular vision line of sight of the second person and the audio feed, the second person intended to perform the same assembly task at the second location, transmitting, from the second location, at least one video feed of the second person performing the assembly task, and receiving, at the first location, the at least one video feed for display on a screen within a monocular vision line of sight of the first person, such that the first person can review the performance of the assembly task by the second person and provided at least one of audio instructions and video instructions directed to the second person regarding the assembly task.

In yet another embodiment, a training method for a manual task is provided. The method includes providing, from an instructor location, a plurality of video feeds of the manual task being performed, at least one of the video feeds based on a line of sight of the instructor, receiving the video feeds at one or more remote locations where the manual task is to be performed, at least one of the video feeds being displayed within a line of sight of the person selected to perform the manual task such that the selected person may view the instructor performing the manual task substantially concurrently with their performance of the manual task, providing, from each of the one or more remote locations, a plurality of video feeds of the selected person performing the manual task, at least one of the video feeds from each location based on a line of sight of the selected person performing the manual task, and receiving the video feeds at the instructor location, at least one of the video feeds being displayed within a line of sight of the instructor such that the instructor may view at least one of the selected persons students performing the manual task substantially concurrently with the instructor performance of the manual task.

The features, functions, and advantages that have been discussed can be achieved independently in various embodiments or may be combined in yet other embodiments further details of which can be seen with reference to the following description and drawings.

### BRIEF DESCRIPTION OF THE DRAWINGS

FIG. 1 is a flow diagram of an aircraft production and service methodology.

FIG. 2 is a block diagram of an aircraft.

FIG. 3 is a flowchart illustrating a real-time video and audio training and training feedback process.

FIG. 4 is a diagram of a real-time video and audio training and training feedback system.

### DETAILED DESCRIPTION

The described embodiments relate to a teaching and clear communication tool that creates a preferred teaching environment, for example, for like kind assembly occurring at disparate locations. Such embodiments may also be referred to as a remote on the job training tool and method. A field view camera system is one current interactive video conferencing system. The described embodiments expand this video conferencing system to include with a helmet mounted camera and a flip-down helmet mounted monitor to enhance the virtual training options, creating a 360 degree feedback link.

Aircraft assembly knowledge teachers, and their cross country and/or internationally located students are able to communicate via video and audio in real-time. In one practical example, a passenger door rigging teacher can guide, in real time, other door rigging teams (students) in disparate locations, as they touch their respective doors and rigging tools. In one embodiment, the teacher utilizes the helmet mounted camera and the helmet mounted flip down LCD monitor that allows the teacher to view and speak to his students as they view and listen, in real time, his teaching instructions, since the students are also equipped with the helmet mounted camera and helmet mounted flip down LCD monitor. In embodiments, the monitor is a split screen monitor so that the user can view both the field view and the view from one of the helmet mounted cameras. Utilizing such a teaching tool allows for quick and simple to execute real time corrections and fine tuning assembly techniques.

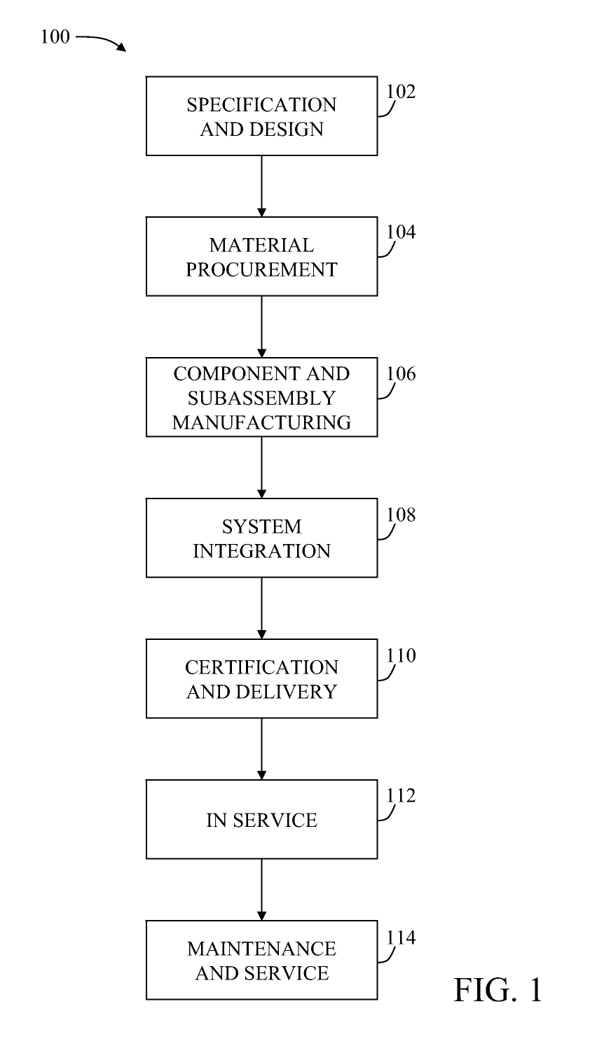

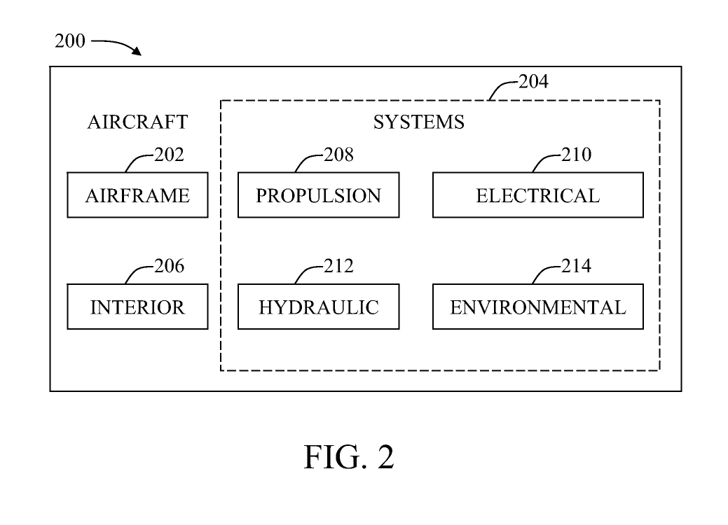

Referring more particularly to the drawings, embodiments of the disclosure may be described in the context of aircraft manufacturing and service method 100 as shown in FIG. 1 and an aircraft 200 as shown in FIG. 2. During pre-production, aircraft manufacturing and service method 100 may include specification and design 102 of aircraft 200 and material procurement 104.

During production, component and subassembly manufacturing 106 and system integration 108 of aircraft 200 takes place. Thereafter, aircraft 200 may go through certification and delivery 110 in order to be placed in service 112. While in service by a customer, aircraft 200 is scheduled for routine maintenance and service 114 (which may also include modification, reconfiguration, refurbishment, and so on).

Each of the processes of aircraft manufacturing and service method 100 may be performed or carried out by a system integrator, a third party, and/or an operator (e.g., a customer). For the purposes of this description, a system integrator may include, without limitation, any number of aircraft manufacturers and major-system subcontractors; a third party may include, for example, without limitation, any number of venders, subcontractors, and suppliers; and an operator may be an airline, leasing company, military entity, service organization, and so on.

As shown in FIG. 2, aircraft 200 produced by aircraft manufacturing and service method 100 may include airframe 202 with a plurality of systems 204 and interior 206. Examples of systems 204 include one or more of propulsion system 208, electrical system 210, hydraulic system 212, and environmental system 214. Any number of other systems may be included in this example. Although an aerospace example is shown, the principles of the disclosure may be applied to other industries, such as the automotive industry.

Apparatus and methods embodied herein may be employed during any one or more of the stages of aircraft manufacturing and service method 100. For example, without limitation, components or subassemblies corresponding to component and subassembly manufacturing 106 may be fabricated or manufactured in a manner similar to components or subassemblies produced while aircraft 200 is in service.

Also, one or more apparatus embodiments, method embodiments, or a combination thereof may be utilized during component and subassembly manufacturing 106 and system integration 108, for example, without limitation, by substantially expediting assembly of or reducing the cost of aircraft 200. Similarly, one or more of apparatus embodiments, method embodiments, or a combination thereof may be utilized while aircraft 200 is in service, for example, without limitation, to maintenance and service 114 may be used during system integration 108 and/or maintenance and service 114 to determine whether parts may be connected and/or mated to each other.

The description of the different advantageous embodiments has been presented for purposes of illustration and description, and is not intended to be exhaustive or limited to the embodiments in the form disclosed. Many modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

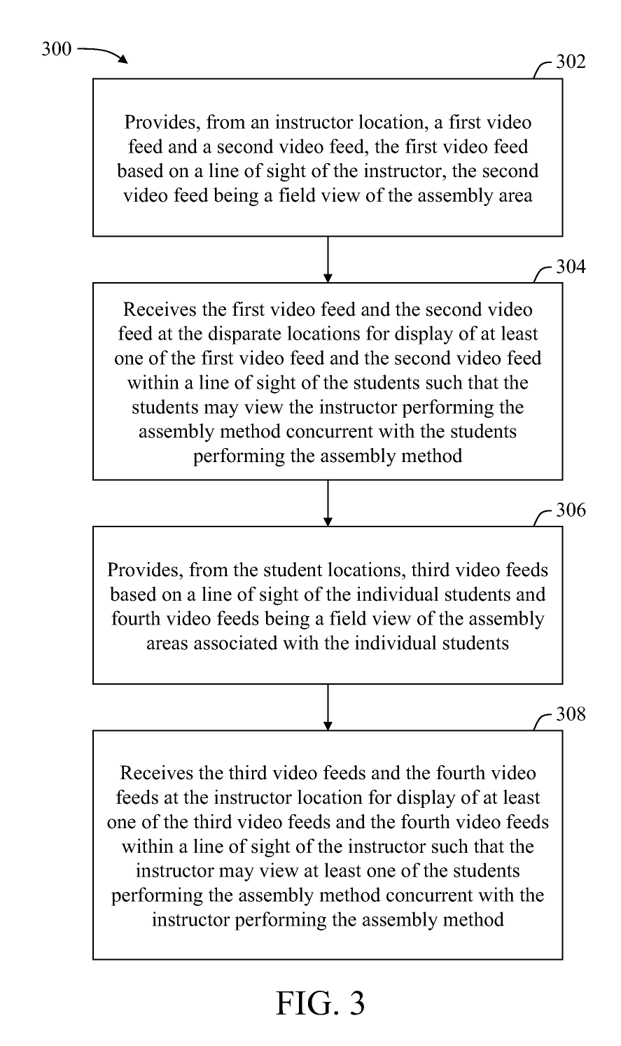

Turning now to FIG. 3, a flowchart 300 describes the method for teaching an aircraft assembly method to students at locations separate from the location of an instructor. The method includes providing 302, from the instructor location, a first video feed and a second video feed, the first video feed based on a line of sight of the instructor, the second video feed being a field view of the assembly area. The first video feed and the second video feed are received 304 at the disparate locations for display of at least one of the first video feed and the second video feed within a line of sight of the students such that the students may view the instructor performing the assembly method concurrent with the students performing the assembly method.

The method further includes providing 306, from the student locations, third video feeds based on a line of sight of the individual students and fourth video feeds being a field view of the assembly areas associated with the individual students. The third video feeds and the fourth video feeds are received 308 at the instructor location for display of at least one of the third video feeds and the fourth video feeds within a line of sight of the instructor such that the instructor may view at least one of the students performing the assembly method concurrent with the instructor performing the assembly method.

In embodiments, the method further includes providing an audio feed from the instructor location to the student locations, and providing an audio feed from the student locations to the instructor location. In embodiments, a switching mechanism is provided for switching the video feed being provided to the line of sight of the students. In other embodiments, a switching mechanism for switching the video feed being provided to the line of sight of the instructor. In various embodiments the switching mechanism is operable by one or both of the students and the teacher.

As described above, embodiments of receiving the video feed include displaying the video feed on a user-mounted monitor mounted in the line of sight of the user. Specific embodiments of the user-mounted monitor include a user mounted monitor that utilizes monocular vision enhancement, particularly a flip down split screen LCD monitor mounted to headwear worn by the user.

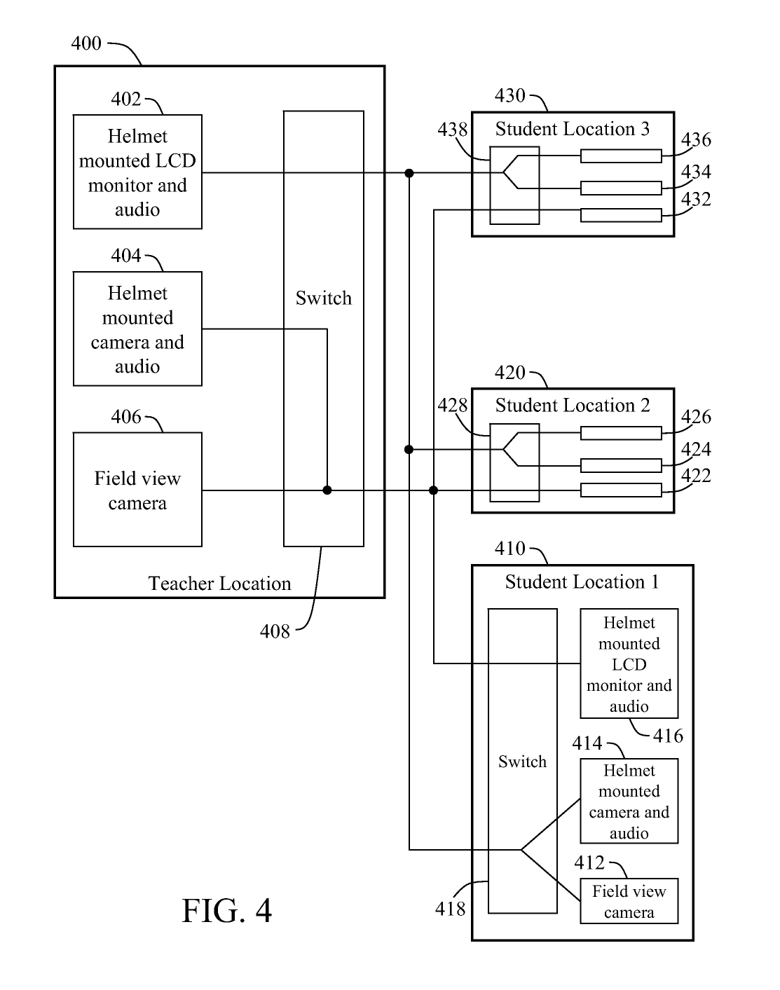

FIG. 4 is a diagram illustrating the components utilized to carry out the above described process. At a teacher location 400, the instructor is equipped with a helmet mounted monitor and audio system 402. In addition, a helmet mounted camera and audio system 404 is provided. A field view camera 406 is mounted at a location where it can obtain images that provide a more expansive view of the environment in which the instructor is working. Operation of switch 408 is described below.

At each student location 410, 420, and 430 (though more and fewer student locations are contemplated) respective helmet mounted monitor and audio systems 412, 422, 432, helmet mounted camera and audio systems 414, 424, 434, and field view cameras 416, 426, and 436 are provided as well as switches 418, 428, and 438.

As easily understood, through incorporation of split screen LCD monitors and switching capabilities, user can select to view the two views provided at the teacher location, the two views of one of the student locations or any combination of student and teacher locations. The communications medium between the disparate locations is generally not material to the described embodiments and can be any one of or a combination of satellite, computer network, and cellular communications, implementations of which are known.

In practice, the students are able to watch the teacher go through the assembly steps, and then the teacher is able to selectively view the students in the disparate locations go through the same assembly steps. Through the audio connection, the students are able to ask questions of the teacher and the teacher is able to provide instruction when he notices that one of the students is about to, or has made, an assembly error. Such system and methods provide nearly instantaneous feedback from one or more sources located in widely separated facilities.

Alternative embodiments allow for switching between the feeds to the monitors to be accomplished through verbal commands, via word recognition switching software, to provide a hands-free switching solution. For example and in one embodiment, the instructor may verbally request a “Group Image”. In response the system would cause his monitor and/or a computer monitor to display images from each of the student locations, dividing up the screens as necessary, with all the student locations appearing as separate images. The instructor may also make a verbal command of “five seconds”, and each student location would be individually shown for about five seconds.

Duplicate final assembly production lines that are separated by significant distances need quick, accurate, production data. Simple assembly instructions provided by a teacher, in real time audio and video, from a first location to students assemblers in disparate locations provides a valuable and efficient training tool. Review of the tasks being performed by the student assemblers by the teacher, also in real time audio and video, further add to the efficiency as training instructions can instantaneously be interjected to the students, by the teacher, as the students perform the assembly tasks. Switching of the real time video and audio allows for a group of students in disparate locations to see (and hopefully avoid) assembly errors made by a student in still another location. Of course, this same switching allows for the group of students to see correct assembly implementations made by the student as well.

This written description uses examples to disclose various embodiments, which include the best mode, to enable any person skilled in the art to practice those embodiments, including making and using any devices or systems and performing any incorporated methods. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method for teaching an aircraft assembly method to students at locations separate from the location of an instructor, said method comprising:
providing, from the instructor location, a first video feed and a second video feed, the first video feed based on a line of sight of the instructor, the second video feed being a field view of the assembly area;
receiving the first video feed and the second video feed at the disparate locations for display of at least one of the first video feed and the second video feed within a line of sight of the students such that the students may view the instructor performing the assembly method concurrent with the students performing the assembly method;
providing, from the student locations, third video feeds based on a line of sight of the individual students and fourth video feeds being a field view of the assembly areas associated with the individual students; and
receiving the third video feeds and the fourth video feeds at the instructor location for display of at least one of the third video feeds and the fourth video feeds within a line of sight of the instructor such that the instructor may view at least one of the students performing the assembly method concurrent with the instructor performing the assembly method.

2. The method according to claim 1 further comprising:
providing an audio feed from the instructor location to the student locations; and
providing an audio feed from the student locations to the instructor location.

3. The method according to claim 1 further comprising providing a switching mechanism, operable by the instructor, for switching the video feed being provided to the line of sight of the students.

4. The method according to claim 1 further comprising providing a switching mechanism, operable by the instructor, for switching the video feed being provided to the line of sight of the instructor.

5. The method according to claim 1 wherein receiving the video feed comprises displaying the video feed on a user-mounted monitor mounted in the line of sight of the user.

6. The method according to claim 5 wherein displaying the video feed on a user-mounted monitor comprises displaying the video feed on a user mounted monitor that utilizes monocular vision enhancement.

7. The method according to claim 5 wherein displaying the video feed on a user-mounted monitor comprises displaying the video feed on a flip down split screen LCD monitor mounted to headwear worn by the user.

8. A real-time training system comprising:
a user mountable camera and monitor at a first location;
a user mountable monitor at the first location;
a field view camera at the first location;
a user mountable camera and monitor at each of a plurality of second locations;
a user mountable monitor at each of the second locations;
a field view camera at each of the second locations; and
a switching mechanism operable such that users at the second locations are provided video feeds onto the user mountable monitors at the second locations from at least one of the user mounted camera and the field view camera at the first location and the user at the first location is provided video feeds onto the user mountable monitors at the first location from at least one of the user mountable camera and the field view camera at the second location.

9. The real-time training system according to claim 8 further comprising:
an audio transceiver at the first location; and
an audio transceiver at each of the second locations, operable for providing bi-directional audio feeds between the first location and each of the second locations.

10. The real-time training system according to claim 8 wherein said user mountable cameras comprise a camera oriented to a line of sight of the user when said camera is user mounted.

11. The real-time training system according to claim 8 wherein said user mountable monitors comprise a monitor mounted within a monocular vision line of sight of the user when said monitor is user mounted.

12. The real-time training system according to claim 11 wherein said user mountable monitors comprise LCD split screen monitors such that a video feed from multiple ones of the field view cameras and user mountable cameras may be provided to said monitors at different locations.

13. The real-time training system according to claim 11 wherein said user mountable monitors comprise flip down monitors mountable to headwear to be worn by a user.

14. A parallel assembly method comprising:
providing a bi-directional audio communications path between a first person at a first location and a second person at a second location;
transmitting, from the first assembly location, at least one video feed of the first person performing an assembly task at the first location;
receiving, at the second location, the at least one video feed for display on a screen within a monocular vision line of sight of the second person and the audio feed, the second person intended to perform the same assembly task at the second location;
transmitting, from the second location, at least one video feed of the second person performing the assembly task; and
receiving, at the first location, the at least one video feed for display on a screen within a monocular vision line of sight of the first person, such that the first person can review the performance of the assembly task by the second person and provided at least one of audio instructions and video instructions directed to the second person regarding the assembly task.

15. The parallel assembly method according to claim 14 wherein transmitting at least one video feed of the first person performing an assembly task comprises transmitting a video feed from a camera oriented to a line of sight of the person performing an assembly task.

16. The parallel assembly method according to claim 14 wherein receiving the at least one video feed for display on a screen comprises displaying the video feeds on LCD split screen monitors such that a video feed from multiple cameras may be provided to the monitors.

17. The parallel assembly method according to claim 14 further comprising operating a switching mechanism for independently selecting which video feed is being provided to each of the first location and the second location.

18. A training method for a manual task, said method comprising:
providing, from an instructor location, a plurality of video feeds of the manual task being performed, at least one of the video feeds based on a line of sight of the instructor;
receiving the video feeds at one or more remote locations where the manual task is to be performed, at least one of the video feeds being displayed within a line of sight of the person selected to perform the manual task such that the selected person may view the instructor performing the manual task substantially concurrently with their performance of the manual task;
providing, from each of the one or more remote locations, a plurality of video feeds of the selected person performing the manual task, at least one of the video feeds from each location based on a line of sight of the selected person performing the manual task; and
receiving the video feeds at the instructor location, at least one of the video feeds being displayed within a line of sight of the instructor such that the instructor may view at least one of the selected persons students performing the manual task substantially concurrently with the instructor performance of the manual task.

19. The method according to claim 18 further comprising providing a switching mechanism, operable by the instructor, for switching the number of video feeds being provided to their line of sight.

20. The method according to claim 18 further comprising providing a switching mechanism, operable by the instructor, for switching the video feed being provided to the line of sight of each selected person.
